(19) United States
(12) Patent Application Publication
(10) Pub. No.: US 2008/0205054 A1
(43) Pub. Date: Aug. 28, 2008

(54) Indirect lighting apparatus

(76) Inventor: Shunkeng Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/889,530

(22) Filed: Aug. 14, 2007

(30) Foreign Application Priority Data
Feb. 27, 2007 (TW) 096203337

(51) Int. Cl. F21V 21/00; F21V 7/00

(52) U.S. Cl. 362/235; 362/257; 362/296

(57) ABSTRACT

An indirect lighting apparatus is disclosed to include a lamp holder, which has a mounting panel for quick installation in a wall or support and holding one or a number of light emitting devices, and a baffle, which has a coupling portion coupled to a coupling portion of the lamp holder and one baffle surface, which defines with the lamp holder a light path for the passing of the light of the light emitting device to prohibit the light of the light emitting device from dazzling people's eyes.

### BACKGROUND OF THE INVENTION

1. Field of the Invention

The present invention relates to a lighting apparatus and more particularly, to an indirect lighting apparatus that is easy to install.

2. Description of the Related Art

Following the creation of incandescent light bulb, lighting apparatus is used to light up every corner around the world. Further, fast development of technology also brings great convenience to our daily life and enables us to enjoy prosperous living. Nowadays, many new designs of lighting apparatus are created to make our lives more comfortable. An indirect lighting apparatus is a product accordingly.

Conventionally, the construction of an indirect lighting apparatus is to make a recessed hole in a wall, and then to install a lamp tube in the recessed hole so that the light of the lamp tube will not be too glaring like having something prickle your eyes. Alternatively, an indirect lighting apparatus may be constructed by: fastening wooden slats on a wall and then installing lamp bulbs in gaps among the wooden slats.

The aforesaid two methods of constructing an indirect lighting apparatus are complicated and require much labor and cost. Therefore, the aforesaid two methods are not economic.

Further, because the aforesaid first method needs to make a hole on a wall for lamp bulb, it destructs the wall structure, frightening building safety. The aforesaid second method uses a big amount of wooden slats and reduces the available indoor space.

FIG. 1 illustrates another design of indirect lighting structure 10 according to the prior art. According to this design, a mount 11 is perpendicularly fastened to a wall 15 to hold a lamp 111 at the top side of the mount 11 such that the outwardly extending free end of the mount 11 blocks a part of light rays from the lamp 111, prohibiting the light of the lamp 111 from dazzling people's eyes and thus producing an indirect lighting effect. For the sakes of space and material cost, the mount 11 is formed of a plate member and fixedly fastened to the wall 15 with fastening members, for example, steel nails 17. However, due to limited contact area between the mount 11 and the wall 15, fixing the mount 11 to the wall 15 with steel nails 17 still cannot prohibit falling of the mount 11 from the wall 15 accidentally. Further, because the indirect lighting structure 10 allows light rays to go in one direction only, there is a dead illumination corner, producing an unpleasant shadow zone.

### SUMMARY OF THE INVENTION

The present invention has been accomplished under the circumstances in view. It is one object of the present invention to provide an indirect lighting apparatus, which is easy and quick to install.

It is one object of the present invention to provide an indirect lighting apparatus, which is comprised of a lamp holder and a baffle separately provided for easy and quick installation.

It is another object of the present invention to provide an indirect lighting apparatus, which has at least one mounting panel provided at the lamp holder thereof for quick installation in a wall with less labor.

It is still another object of the present invention to provide an indirect lighting apparatus, which has an illumination surface provided at the lamp holder and connected to the mounting panel of the lamp holder at a predetermined angle for easy installation of light emitting device(s) to provide excellent illumination performance

It is still another object of the present invention to provide an indirect lighting apparatus, which uses a lamp holder having a substantially W-shaped cross section for easy and positive installation in a wall corner.

It is still another object of the present invention to provide an indirect lighting apparatus, which employs a tongue-and-groove joint for quick mounting and dismounting of the lamp holder and baffle thereof.

It is still another object of the present invention to provide an indirect lighting apparatus, which has a diffuse surface or reflective surface provided at the baffle thereof to enhance illumination of indirect lighting.

It is still another object of the present invention to provide an indirect lighting apparatus, which has a shaped surface provided at the baffle thereof and configured subject to the whole space design.

According to one embodiment of the present invention, the indirect lighting apparatus comprises a lamp holder, and a baffle. The lamp holder comprises a coupling portion, at least one mounting panel for fastening to a wall surface, and at least one light emitting device. The baffle comprises a coupling portion coupled to the coupling portion of the lamp holder, and at least one baffle surface, which defines with the lamp holder at least one light path for the passing of light from the at least one light emitting device.

According to another embodiment of the present invention, the indirect lighting apparatus comprises a lamp holder, and a baffle. The lamp holder comprises a coupling portion, two mounting panels disposed at two sides of the coupling portion of the lamp holder for fastening to a wall surface, and a plurality of light emitting devices respectively disposed between the mounting panels and the coupling portion of the lamp holder. The baffle comprises a coupling portion coupled to the coupling portion of the lamp holder, and two baffle surfaces disposed at two sides of the coupling portion of the baffle and defining with the lamp holder a respective light path for the passing of light from the at least one light emitting device.

### BRIEF DESCRIPTION OF THE DRAWINGS

FIG. 1 illustrates an indirect lighting structure according to the prior art.

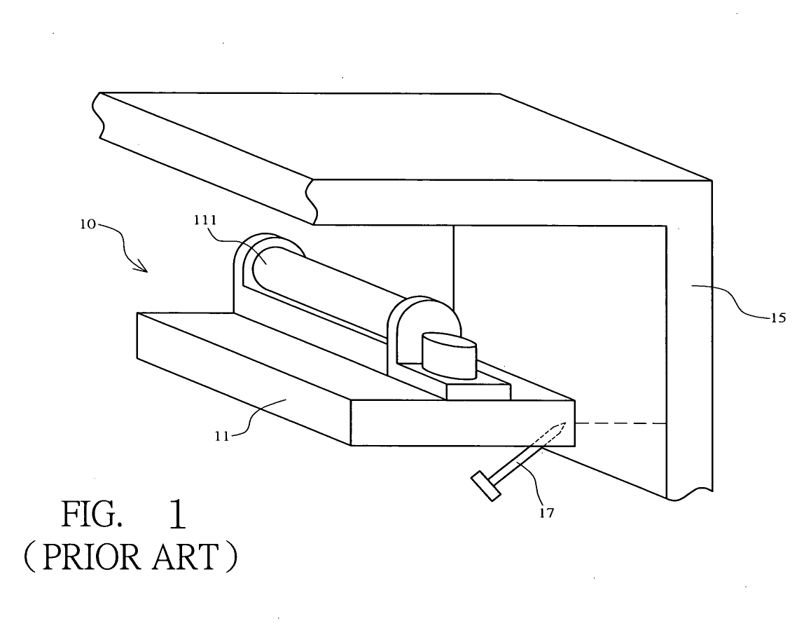

FIG. 2 is a sectional view of an indirect lighting apparatus in accordance with a first embodiment of the present invention.

FIG. 3 is an elevational view of the indirect lighting apparatus in accordance with the first embodiment of the present invention.

FIG. 4 is a sectional view of an indirect lighting apparatus in accordance with a second embodiment of the present invention.

FIG. 5 is a sectional view of an indirect lighting apparatus in accordance with a third the present invention.

FIG. 6 is a sectional view of an indirect lighting apparatus in accordance with a fourth the present invention.

FIG. 7 is a sectional view of an indirect lighting apparatus in accordance with a fifth the present invention.

FIG. 8 is a sectional view of an indirect lighting apparatus in accordance with a sixth the present invention.

### DETAILED DESCRIPTION OF THE PREFERRED EMBODIMENT

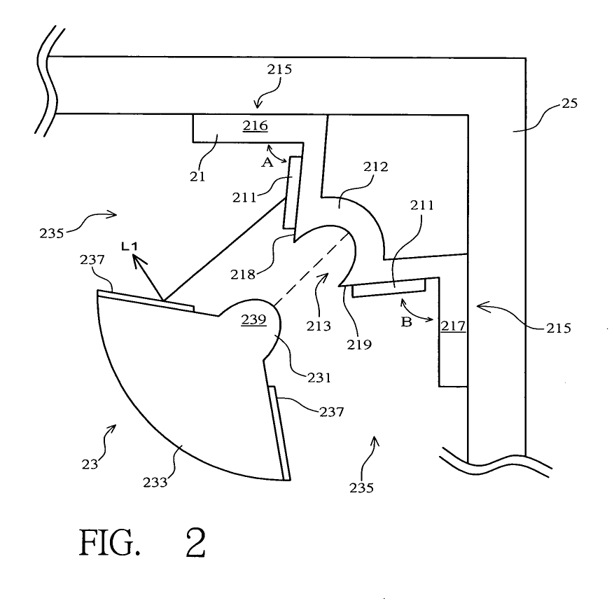

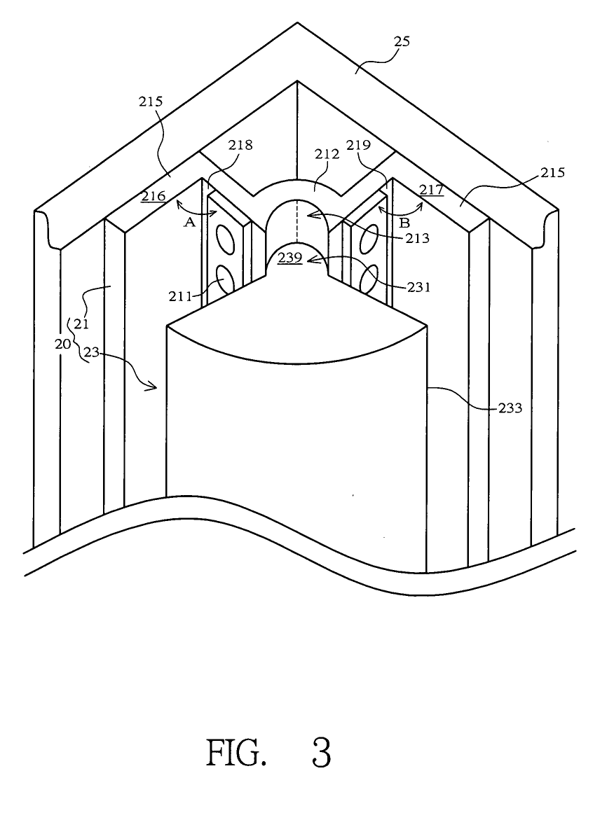

Referring to FIGS. 2 and 3, an indirect lighting apparatus 20 in accordance with one embodiment of the present invention is shown comprised of a lamp holder 21 and a baffle 23. The lamp holder 21 comprises a plurality of light emitting devices 211, and a coupling portion 212. The lamp holder 21 is fixedly fastened to a wall corner 25 (or the surface of a support frame). The baffle 23 comprises a coupling portion 231 fastened to the coupling portion 212 of the lamp holder 21. After connection of the coupling portion 231 of the baffle 23 to the coupling portion 212 of the lamp holder 21, at least one light path 235 is defined between the lamp holder 21 and the baffle 23 for letting the light of the light emitting devices 211 pass to the outside.

The lamp holder 21 further comprises a first mounting panel 216 and a second mounting panel 217 for fastening to the wall corner 25. The first mounting panel 216 and the second mounting panel 217 are abutted against each other at a predetermined angle such that the first mounting panel 216 and the second mounting panel 217 fit the wall corner 25 perfectly after installation. By means of the first mounting panel 216 and the second mounting panel 217, the lamp holder 21 can easily and quickly be installed in the wall corner 25. Because the first mounting panel 216 and the second mounting panel 217 fit the wall corner 25 perfectly, the lamp holder 21 will not fall from the wall corner 25 after installation. The first mounting panel 216 and the second mounting panel 217 provide a first illumination surface 218 and a second illumination surface 219 for the mounting of the light emitting devices 211. The first mounting panel 216 and the second mounting panel 217 are angled panels, each defining a contained angle A or B for gathering light from the light emitting devices 211 in direction toward the at least one light path 235, enhancing the lighting efficiency.

As illustrated, the lamp holder 21 shows a substantially W-shaped cross section for easy installation in the wall corner 25 or an angled wall surface of a support frame or the like.

The baffle 23 comprises two baffle surfaces 237 at two sides of the coupling portion 231 for blocking a part of emitting angle of the light emitting devices 211, achieving the desired indirect illumination effect. The baffle 23 further comprises a shaped face 233 disposed outside the coupling portion 231 and the baffle surfaces 237. The shaped face 233 is configured subject to the whole space design.

Further, the baffle surfaces 237 can be diffuse surfaces or reflective surfaces to guide light rays from the light emitting devices 211 toward the at least one light path 235, improving the illumination efficiency of the indirect lighting apparatus 20.

According to this embodiment, the coupling portion 212 of the lamp holder 21 is comprised of a coupling groove 213, and the coupling portion 231 of the baffle 23 is comprised of a coupling flange 239 directly and tightly fitted into the coupling groove 213 to secure the baffle 23 to the lamp holder 21.

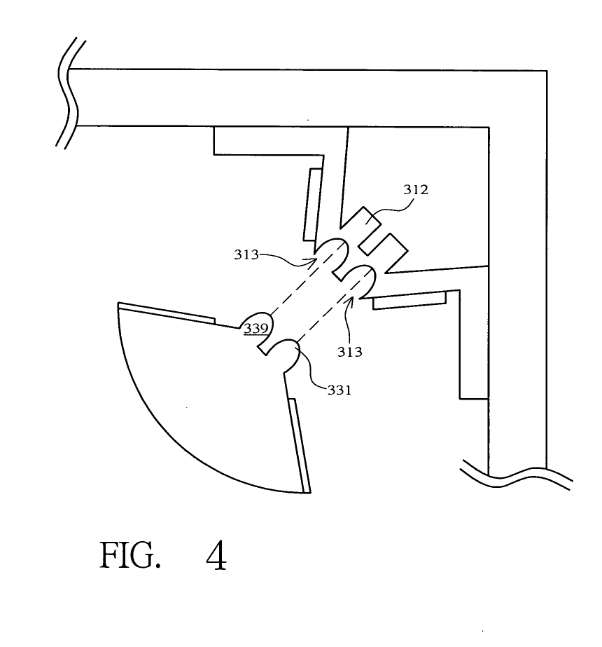

FIG. 4 shows an indirect lighting apparatus in accordance with a second embodiment of the present invention. This second embodiment is substantially similar to the aforesaid first embodiment with the exception that the coupling portion 312 of the lamp holder is comprised of a plurality of coupling grooves 313, and the coupling portion 331 of the baffle is comprised of a plurality of coupling flanges 239 respectively tightly fitted into the coupling grooves 313 to secure the baffle to the lamp holder.

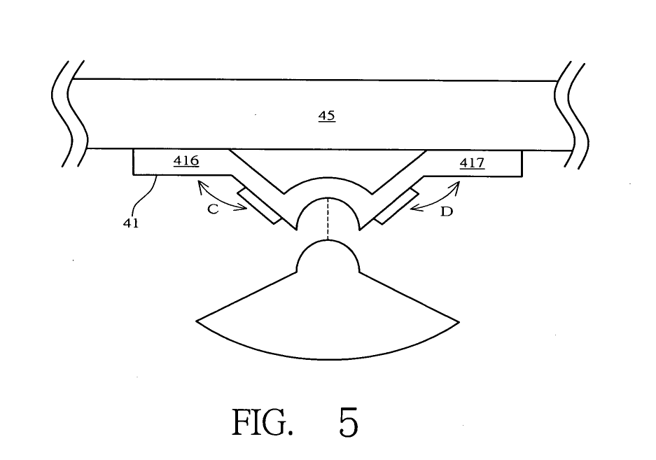

FIG. 5 shows an indirect lighting apparatus in accordance with a third embodiment of the present invention. This third embodiment is substantially similar to the aforesaid first embodiment with the exception that the first mounting panel 416 and the second mounting panel 417 define a respective contained angle C or D relatively greater than that of the first mounting panel and the second mounting panel of the aforesaid first embodiment such that the first mounting panel 416 and the second mounting panel 417 each have a part disposed on one same plane for fixation to a flat wall surface 45.

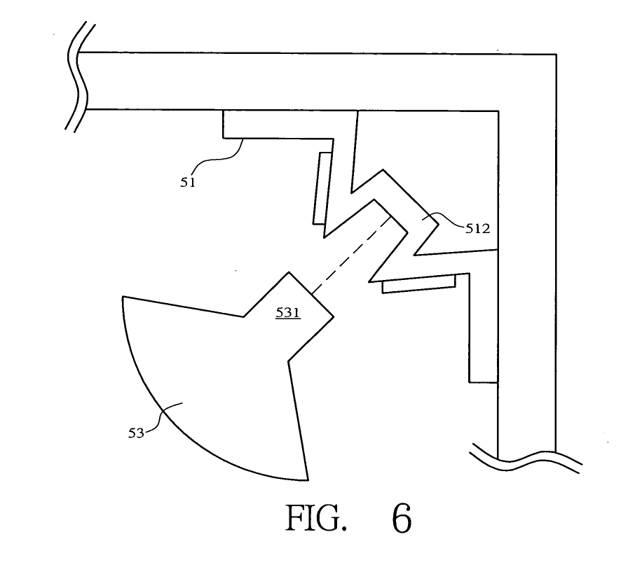

FIG. 6 shows an indirect lighting apparatus in accordance with a fourth embodiment of the present invention. This fourth embodiment is substantially similar to the aforesaid first embodiment with the exception that the coupling portion 512 of the lamp holder 51 is a groove and the coupling portion 531 of the baffle 53 is a tongue for fastening to the groove of the coupling portion 512 of the lamp holder 51, i.e., the baffle 53 is detachably connected to the lamp holder 51 by a tongue-and-groove joint.

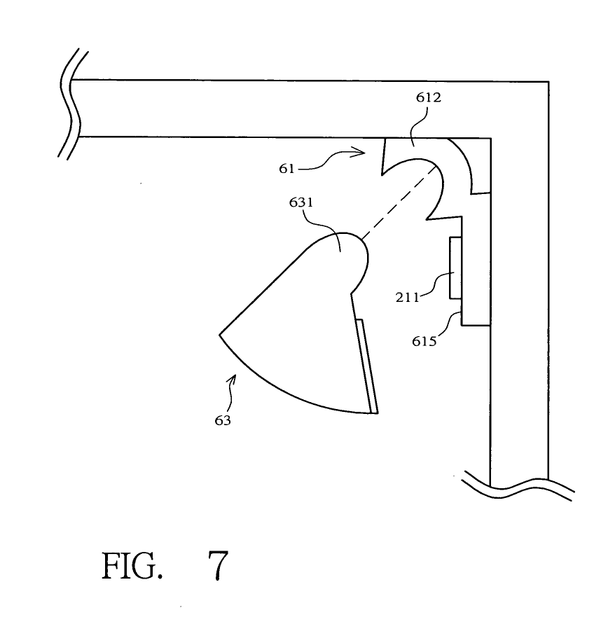

FIG. 7 shows an indirect lighting apparatus in accordance with a fifth embodiment of the present invention. According to this fifth embodiment, the lamp holder 61 has only one coupling portion 612 and one mounting panel 615 the light emitting devices 611 are installed in the mounting panel 615 adjacent to the coupling portion 612 the baffle 63 has one coupling portion 615 coupled to the coupling portion 612 of the lamp holder 61.

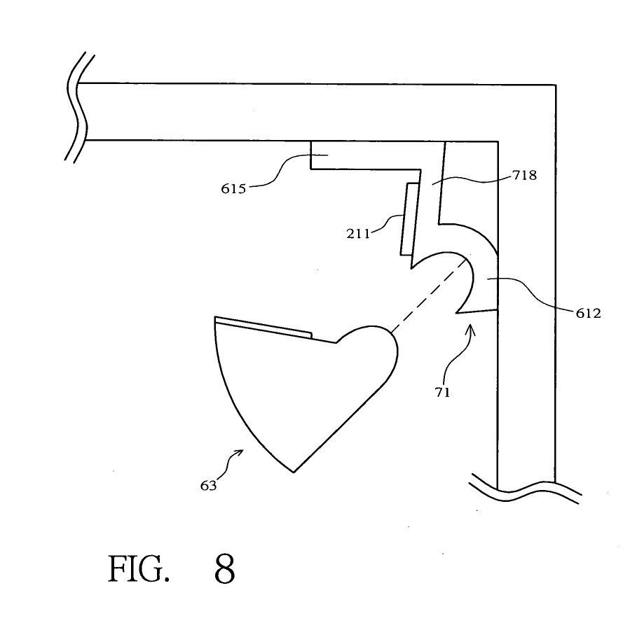

FIG. 8 shows an indirect lighting apparatus in accordance with a sixth embodiment of the present invention. This sixth embodiment is substantially similar to the aforesaid fifth embodiment with the exception that the lamp holder 71 has an illumination surface 718 defined between the coupling portion 612 and the mounting panel 615 for the installation of the light emitting devices 611.

Further, the light emitting devices 211 in the aforesaid various different embodiments can be light emitting diodes, lamp tubes, incandescent lamp bulbs, or fluorescent lamp tubes.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An indirect lighting apparatus comprising:
a lamp holder, said lamp holder comprising a coupling portion, at least one mounting panel for fastening to a wall surface, and at least one light emitting device; and
a baffle, said baffle comprising a coupling portion coupled to the coupling portion of said lamp holder, and at least one baffle surface, which defines with said lamp holder at least one light path for the passing of light from said at least one light emitting device.

2. The indirect lighting apparatus as claimed in claim 1, wherein the coupling portion of said lamp holder comprises at least one coupling groove, and the coupling portion of said baffle comprises at least one coupling flange respectively fastened to the at least one coupling groove of the coupling portion of said lamp holder.

3. The indirect lighting apparatus as claimed in claim 1, wherein said lamp holder comprises at least one illumination surface connected between said coupling portion and said at least one mounting panel at an angle for the mounting of said at least one light emitting device.

4. The indirect lighting apparatus as claimed in claim 1, wherein said at least one light emitting device each is selected from one of light emitting diode, lamp tube, incandescent lamp bulb, fluorescent lamp bulb.

5. The indirect lighting apparatus as claimed in claim 1, wherein said baffle comprises a shaped face beyond said coupling portion and said at least one baffle surface.

6. The indirect lighting apparatus as claimed in claim 1, wherein said at least one baffle surface each is a diffuse surface.

7. The indirect lighting apparatus as claimed in claim 1, wherein said at least one baffle surface each is a reflective surface.

8. An indirect lighting apparatus comprising:
a lamp holder, said lamp holder comprising a coupling portion, two mounting panels disposed at two sides of the coupling portion of said lamp holder for fastening to a wall surface, and a plurality of light emitting devices respectively disposed between said mounting panels and the coupling portion of said lamp holder; and
a baffle, said baffle comprising a coupling portion coupled to the coupling portion of said lamp holder, and two baffle surfaces disposed at two sides of the coupling portion of said baffle and defining with said lamp holder a respective light path for the passing of light from said at least one light emitting device.

9. The indirect lighting apparatus as claimed in claim 8, wherein the coupling portion of said lamp holder comprises at least one coupling groove, and the coupling portion of said baffle comprises at least one coupling flange respectively fastened to the at least one coupling groove of the coupling portion of said lamp holder.

10. The indirect lighting apparatus as claimed in claim 8, wherein said lamp holder comprise two illumination surfaces respectively connected the mounting panels and coupling portion of said lamp holder and for the mounting of said light emitting devices.

11. The indirect lighting apparatus as claimed in claim 10, wherein said illumination surfaces are respectively connected to said mounting panels at a predetermined angle.

12. The indirect lighting apparatus as claimed in claim 11, wherein said lamp holder has a W-shaped cross section.

13. The indirect lighting apparatus as claimed in claim 8, wherein said at least one light emitting device each is selected from one of light emitting diode, lamp tube, incandescent lamp bulb, fluorescent lamp bulb.

14. The indirect lighting apparatus as claimed in claim 8, wherein said baffle comprises a shaped face beyond the coupling portion and baffle surfaces of said baffle.

15. The indirect lighting apparatus as claimed in claim 8, wherein said baffle surfaces are diffuse surfaces.

16. The indirect lighting apparatus as claimed in claim 8, wherein said baffle surfaces are reflective surfaces.
